(19) United States
(12) Patent Application Publication
(10) Pub. No.: US 2018/0187819 A1
(43) Pub. Date: Jul. 5, 2018

(54) ATTACHMENT FLANGE ASSEMBLY AND METHOD

(71) Applicant: Salco Products, Inc., LaGrange Park, IL (US)

(72) Inventors: Tyler Jepsen, Plainfield, IL (US); Marc Wiktor, Orland Park, IL (US); Larry McMullin, Elwood, IL (US); Griffin Schiele, Lockport, IL (US)

(21) Appl. No.: 15/863,443

(22) Filed: Jan. 5, 2018

Related U.S. Application Data
(60) Provisional application No. 62/442,707, filed on Jan. 5, 2017.

(51) Int. Cl. F16L 55/17; F16L 55/168; F16L 55/18; F16L 21/06

(52) U.S. Cl. CPC F16L 55/17; F16L 21/06; F16L 55/18; F16L 55/1683

(57) ABSTRACT

An attachment flange assembly for connection of a pipe or tube to a wall comprising a pair of annular flange plates configured to be secured together and to the wall in surrounding relation to a tube receiving hole; each flange plate includes a conical surface disposed in diverging face-to-face relation; a pair of generally semi-cylindrical bushing halves define a split bushing assembly positionable to encircle a tubular member and define a radial outward generally spherical surface. A resilient seal ring is interposed between the conical surfaces and said radial outward spherical surface. In one form, the generally semi-cylindrical bushing halves include an internal semi-cylindrical tube receiving surface with at least one radially inward ridge.

### CROSS-REFERENCE TO RELATED APPLICATIONS

This application claims priority pursuant to Title 35 USC § 119(e) to U.S. provisional application Ser. No. 62/442,707, filed Jan. 5, 2017, entitled “Attachment Flange Assembly,” the entire contents of which is hereby incorporated by reference herein as if fully set forth.

### BACKGROUND

This disclosure relates to an attachment flange assembly to connect a pipe or tube to an intersecting surface, such as a wall of a vessel. More particularly, it relates to a pipe or tube attachment flange assembly wherein the pipe or tube may be supported upon a wall through which it passes in a relationship that is other than perpendicular to the wall.

In various industries involving transfer of powders, fluent or particulate materials, such as sand, transfer pipes often pass through, or intersect with, the wall of the containment vessel. One such installation is the inlet tube for a “sand chief” containment vessel utilized in oil extraction processes. Such sand is delivered by vehicular transport and transferred to the sand chief vessel by a pressurized hose connected to one or more inlet tubes. These tubes, usually positioned near the bottom of the vessel, typically extend through a vertical wall. That intersection must be tightly sealed to prevent loss of sand from the containment vessel. Often, circumstances dictate that the angle of the inlet tube relative to its intersection with the vessel wall be variable to accommodate various connection alternatives.

### SUMMARY

In this disclosure, an attachment flange assembly is provided that accommodates a degree of non-perpendicular alignment between the inlet pipe or tube and the vessel wall. The attachment flange assembly of the present disclosure is particularly suitable to attach a tube or pipe to the vertical wall of a containment vessel such as an enclosed sand containment vessel used in the oil industry, often referred to as a “sand chief.” Numerous other and varied uses are contemplated where the pipe or tube does not typically extend perpendicular to the wall it intersects and some degree of angularity must be accommodated.

An attachment flange assembly for connection of a pipe or tube to a wall comprising a pair of annular flange plates configured to be secured together and to the wall in surrounding relation to a tube receiving hole; each flange plate includes a conical surface disposed in diverging face-to-face relation; a pair of generally semi-cylindrical bushing halves define a split bushing assembly positionable to encircle a tubular member and define a radial outward generally spherical surface. A resilient seal ring is interposed between the conical surfaces and said radial outward spherical surface. In one form, the generally semi-cylindrical bushing halves include an internal semi-cylindrical tube receiving surface with at least one radially inward ridge.

### DESCRIPTION OF THE DRAWINGS

Illustrated in the accompanying drawings is an attachment flange assembly for securement of a pipe or tube to an intersected wall. It accommodates a degree of permissible angularity that varies from a perpendicular relationship. The desired capability is achieved through employment of a spherical sealing surface at the pipe/wall interface.

FIG. 1 is a front plan view of a wall upon which is mounted the attachment flange assembly of the present disclosure.

FIG. 2 is a sectional side view, taken along the line 2-2 of FIG. 1 of the attachment flange assembly of the disclosure joining a pipe or tube to the wall of a containment vessel.

FIG. 3 is a fragmentary sectional view, on an enlarged scale, illustrating details of the attachment flange assembly of FIG. 1.

FIG. 4 is a perspective view of a generally semi-cylindrical bushing half of the attachment flange assembly of FIG. 1.

FIG. 5 is a rear plan view of the bushing half of FIG. 4.

FIG. 6 is a sectional view, of the bushing half of FIG. 5, taken along the line 6-6 of FIG. 5.

FIG. 7 is a front plan view of the bushing half of FIG. 4.

FIG. 8 is a front plan view of one of the flange plates of the attachment flange assembly of FIGS. 1 to 3.

FIG. 9 is a sectional view of the flange plate of FIG. 8 taken along the lines 9-9 of FIG. 8.

FIG. 10 is a front plan view of a resilient bushing seal of the attachment flange assembly of the present disclosure.

FIG. 11 is a sectional view of the resilient bushing seal of FIG. 10 taken along the line 11-11 of FIG. 10.

FIG. 12 is a front plan view of the ring seal of the attachment flange assembly of FIGS. 1 to 3.

FIG. 13 is a sectional view of the ring seal of FIG. 12 taken along the lines 13-13 of FIG. 12.

FIG. 14 is a perspective view of a modified form of bushing half.

### DETAILED DESCRIPTION OF THE ILLUSTRATED EMBODIMENTS

Turning now to the drawings, attachment flange assembly, generally designated 10, secures a filler pipe or tube 12 to the wall 14 of a containment vessel. Pipe 12 extends through an aperture 16 in wall 14 to provide communication to the interior of the vessel.

The assembly 10 is configured to permit the pipe or tube 12 to reside at an angle other than perpendicular to the wall 14. It also ensures a leak-tight joint between a pipe or tube 12 and wall 14.

Attachment flange assembly 10 includes a pair of spaced annular flange plates 20 associated with a split annular bushing assembly 30 comprised of joined bushing halves 32. These components, in combination with seal elements 50 and 60, support the pipe or tube 12 in aperture 16 and seal the joint against undesired spillage of the vessel contents.

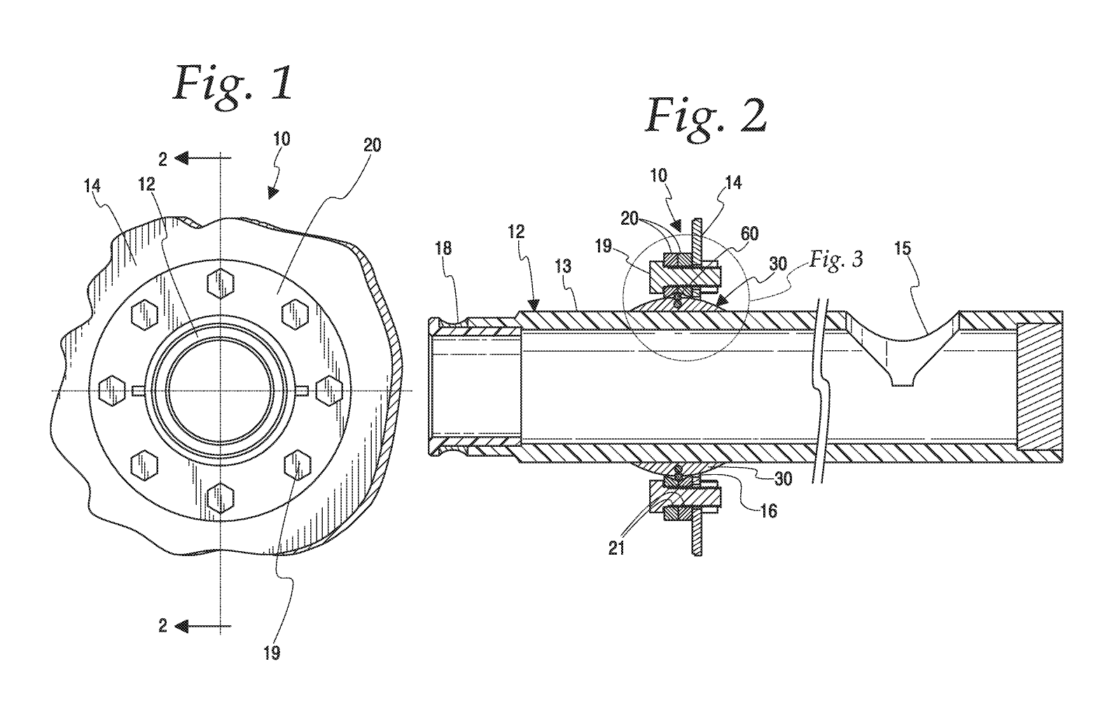

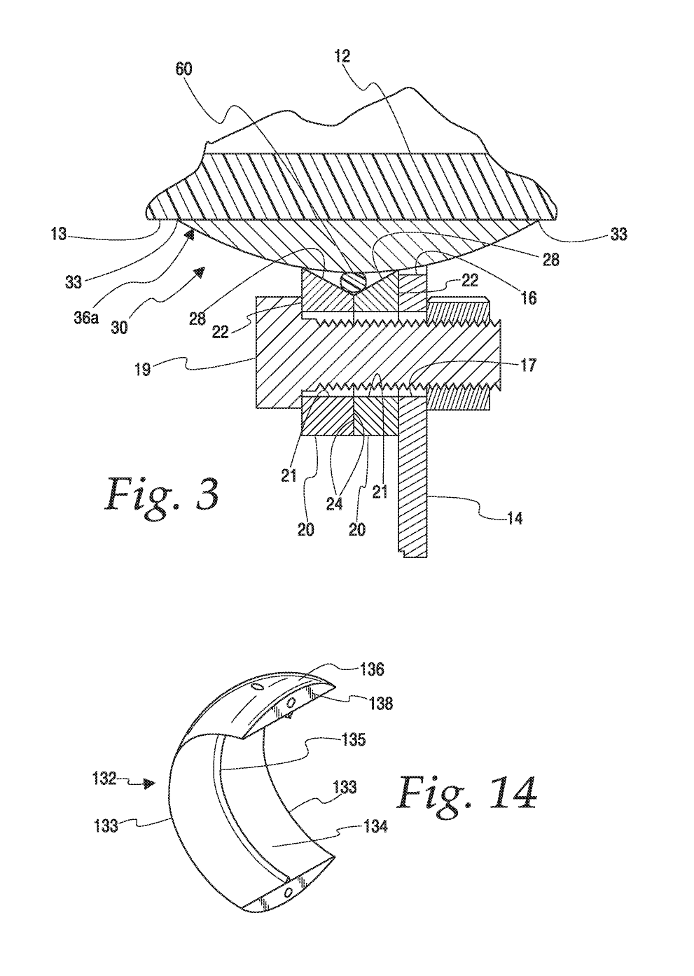

As seen in FIGS. 1-3, pipe 12 has an outer cylindrical surface 13 extending through the aperture 16 in wall 14. Wall 14 has a series of holes 17 on a bolt circle surrounding aperture 16. (Best seen in FIG. 3). Pipe 12 is supported in aperture 16 by assembly 10 through connection of flange plates 20 to an exterior surface wall 14 with suitable fasteners such as bolts 19.

Split annular bushing assembly 30 best seen in FIG. 3, surrounds pipe 12 and is secured to the cylindrical surface of pipe 12. It is interposed between the flange plates 20 and pipe 12 to transfer the load of pipe 12 to wall 14 through flange plates 20.

The arrangement disclosed herein is particularly suitable for a containment vessel for a particulate material such as sand, which includes an attached tube or pipe extending into the vessel through a side wall. The tube 12 may preferably be made of a polymer material such as ultra-high molecular weight polyethylene (UHMWPE). It provides resistance against abrasion due to flow of the contained substance through the pipe. It may include an opening 15 adjacent an end positioned within the interior of the vessel and a connection end outside of the vessel to receive an attached hose. The tube illustrated here has a kamm connector ring 18 at the connection end to receive a hose fitting.

FIG. 2 illustrates pipe 12 passing through wall 14 perpendicular to the wall 18. This angular relation between pipe 12 and wall 14 is adjustable to other than perpendicular as is explained below. This permissible angularity is accommodated by the attachment flange assembly 10 through positioning of the split annular bushing assembly 30 relative to flange plates 20.

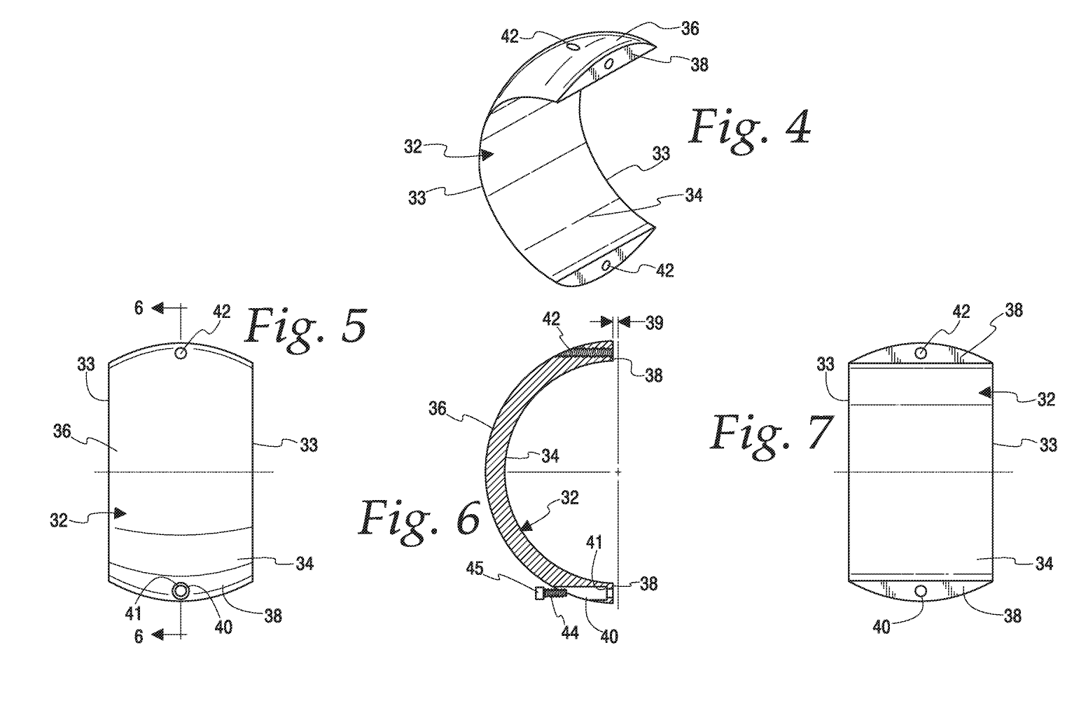

Split annular bushing assembly or collar 30, shown in FIGS. 4 through 7, includes two separate, generally semi-circular bushing halves 32. These may be made of steel. The bushing halves 32 are identical. Each bushing half is of a width along the axis of pipe 12 between axially spaced edges 33 that substantially exceeds the thickness of the wall 14 to which the pipe is attached. Each bushing half 32 includes an internal semi-cylindrical surface 34 for contact with outer cylindrical surface 13 of pipe 12. Each bushing half includes an outer generally semi-circular surface 36 that is spherical between axially spaced edges 33 with maximum radial thickness midway between edges 33.

Bushing halves 32 are sized somewhat less than completely semi-circular between transverse end surfaces 38. They are circumferentially foreshortened an amount designated 39 in FIG. 6. When placed end-to-end, there exists a gap between ends 38 to accommodate movement of the ends 38 toward each other to permit radial inward movement of the bushing halves 32 to enhance the grip contact of internal semi-cylindrical surface 34 with outer cylindrical surface 13 of pipe 12.

Bushing halves 32 are symmetrical, except for bores 40 and 42 midway between axially spaced edges 33 extending from outer spherical surface 36 through the associated transverse end 38. Bore 40 includes a counter-bore to a ledge 41 to capture the enlarged head 45 of a machine screw 44 (seen in FIG. 6). Bore 42 includes threads and receives the threaded end of a machine screw 44 extending from an opposite bushing half. The screws secure the bushing halves together to clamp internal semi-cylindrical surfaces 34 against outer cylindrical surface 13 of pipe 12.

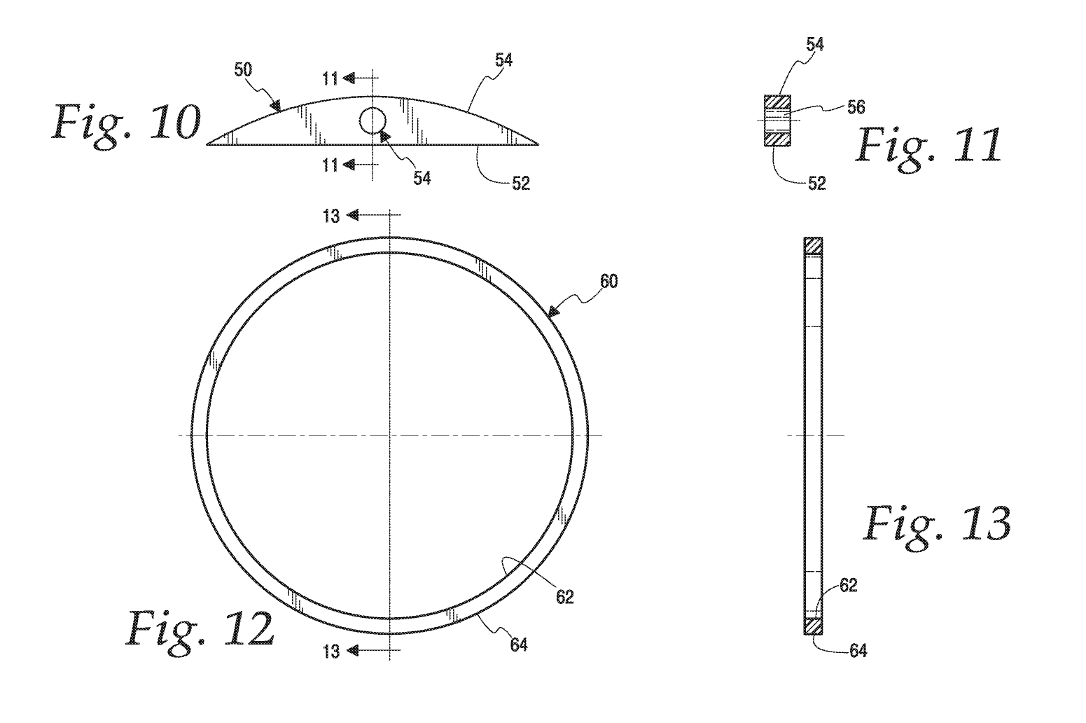

Referring to FIGS. 10 and 11, there is illustrated a resilient bushing seal 50 having a shape that replicates the transverse end surfaces 38. It has a straight side or edge 52 having a length about the same length as the axial width of the bushing half 32 between edges 33. Resilient bushing seal 50 has a semi-circular surface 54 shaped similarly to outer spherical surface 36 between edges 33 of each split bushing half 32. Resilient bushing seal 50 has a centrally located hole 56 to pass machine screws 44.

As seen in FIG. 10, the maximum distance between straight side or edge 52 and semi-circular surface 54 is midway between its edges. It is essentially the same thickness in the radial direction as the maximum radial thickness of split bushing halves 32 midway between edges 33. The contour of surface 54 follows the contour of spherical surface 36 of each bushing half 32.

The split bushing assembly 30 is assembled about pipe or tube 12 with ends 38 facing each other. The bore 40 of one bushing half is aligned with the bore 42 of the other, such that the screw 44 in one bore 40 may be threaded with the bore 42 of the other to secure the bushing halves together.

A resilient bushing seal 50 is disposed between each facing pairs of end surfaces 38. The circumferential thickness of resilient bushing seal 50 is somewhat greater than twice the amount 39 designated in FIG. 6.

On installation of split annular bushing assembly 30 about the outer cylindrical surface 13 of tube 12, machine screws 44 are tightened to secure split bushing assembly 30 to the outer cylindrical surface 13 of pipe 12. The two resilient bushing seals 50 are compressed between facing end surfaces 38 to seal the gap between them. The spherical surfaces of bushing halves 32 and surfaces 54 of resilient bushing seals 50 define a complete outer generally spherical surface 36a. (See FIG. 3).

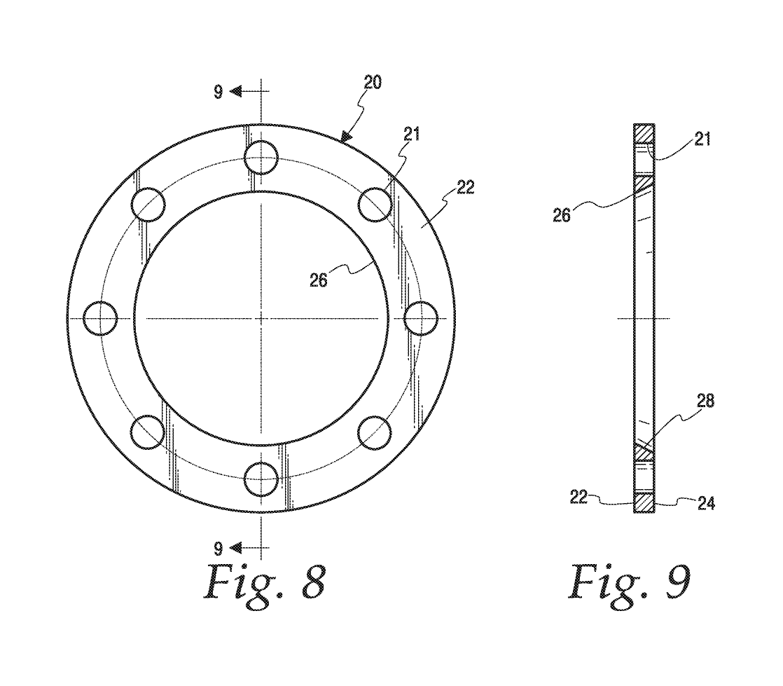

Referring to FIGS. 8 and 9, flange plates 20 are planar annular rings made of steel. Two flange plates 20 are employed in the attachment flange assembly 10. Each flange plate 20 includes a conical contact surface 28 that defines a central bore that diverges from an outer surface 22 to an inner surface 24. Surface 28 defines edge 26 at outer surface 22 that is smaller than the maximum outer diameter across the outer semi-circular spherical surfaces 36 of bushing halves 32, midway between axial edges 33.

Flange plates 20 are positioned with inner surfaces 24 contacting each other in surrounding relation to the outer generally spherical surface 36a of the split bushing assembly 30. This disposition places diverging conical surfaces 28 in face-to-face relation. Each plate 20 includes a plurality of holes 21 positioned about a bolt circle to receive fasteners 19 for attachment of the facing flange plates 20 to the outer surface of wall 14. The flange plates 20 are positioned with holes 21 aligned with each other and with holes 17 in wall 14 to receive securement bolts 19, which clamp the flange plates 20 together and to the exterior surface of wall 14. The flange plates 20 are drawn together by the fasteners 19 extending through holes 21, which also pass through the aligned holes 17 in wall 14.

As best seen in FIG. 3 on assembly of attachment flange assembly 10 to wall 14 divergent conical surfaces 28 surround the outer generally spherical surface 36a of split bushing assembly 30. These surfaces define a void or volume that receives an annular ring seal 60. Ring seal 60 is an annular elastomeric member of generally rectangular cross section, shown in FIGS. 12 and 13. It has an inner cylindrical surface 62 having a diameter such that it is smaller than the maximum outer diameter of the split bushing assembly 30 across the outer generally spherical surface 36a. It also has an outer cylindrical surface 64 having a diameter that may be about the same, or slightly larger than, the maximum diameter across the divergent conical surfaces 28 at inner surfaces 24 of flange plates 20.

As seen in FIG. 3, on assembly, the ring seal 60 is positioned within the void space defined by the outer generally spherical surface 36a of split bushing assembly 30 and the facing diverging conical surfaces 28 of flange plates 20. With bolts 19 tightened, ring seal 60 is placed in compressed sealing contact with surfaces 36 of split bushing halves 32 and 28 of flange plates 20 to provide a leak tight seal. This seal prevents escape of the contents of the vessel defined by wall 14.

To alter the orientation of pipe 12 relative to vertical wall 14, it is only necessary to loosen bolts 19 and reposition the pipe by swiveling split bushing assembly 30 relative to flange plates 20. Once the pipe 12 and split bushing assembly 30 are repositioned, bolts 19 are tightened to reestablish the sealing relationship of ring seal 60.

As illustrated in FIG. 3, the outer generally spherical surface 36a of split bushing assembly 30 accommodates the angularity of the pipe 12 relative to the wall 14. The split bushing assembly 30 on pipe 12 is free to swivel relative the central conical contact surfaces 28 of flange plates 20 (with the bolts 19 sufficiently loosened). The pipe 12 can be positioned at an intersection with wall 14 in a range of about twenty (20) degrees or more from a perpendicular intersection with wall 14. The bolts 19 are then tightened to secure the pipe 12 in place.

In use, pipe or tube 12 experiences forces urging it to move axially relative to its securement within split annular bushing assembly 30. FIG. 14 illustrates a modified form of bushing half 132 intended to enhance resistance to this force. Referring to FIG. 14, two split bushing halves 132 may be employed in a split annular bushing assembly 30 as illustrated in FIGS. 2 and 3, sized and arranged identically to the bushing halves 32 of the earlier embodiment. Bushing half 132, however, includes a modification of inner semi-cylindrical surface 134 for gripping contact with the outer cylindrical surface 13 of pipe or tube 12. In includes a central circumferential ridge 135 intermediate edges 133. Ridge 135 is intended to enhance the connection to pipe or tube 12 on assembly of the two bushing halves 132 upon outer cylindrical surface 13. Ridge 135 may have a triangular cross-section and protrude radially inward about 0.040″ (inches) or more. This modification is merely exemplary of a suitable connection enhancing mechanism. Any effective gripping enhancement configuration could be employed.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

1. An attachment flange assembly for connection of a pipe or tube to a wall comprising:
a pair of annular flange plates configured to be secured to the wall in surrounding relation to a receiving hole;
each said flange plate including a conical contact surface disposed in diverging face-to-face relation;
a pair of generally semi-cylindrical bushing halves defining a split bushing assembly positionable to encircle the pipe or tube and defining an outer generally spherical surface,
a resilient seal ring interposed between said conical contact surfaces and said outer spherical surface.

2. An attachment flange assembly as claimed in claim 1, wherein said generally semi-cylindrical bushing halves include transverse end surfaces and an outer generally semi-circular surface spherical between axially spaced edges.

3. An attachment flange assembly as claimed in claim 2, wherein said generally semi-cylindrical bushing halves are disposed in end-to-end facing relation and said assembly includes a resilient bushing seal between said facing end surfaces.

4. An attachment flange assembly as claimed in claim 3, wherein said conical contact surfaces of said flange plates define an edge that is smaller than the maximum diameter across said spherical surface of said split bushing assembly.

5. An attachment flange assembly as claimed in claim 4, wherein said resilient ring seal is compressed between said conical contact surfaces of said flange plates and said outer generally spherical surface of said split bushing assembly.

6. An attachment flange assembly as claimed in claim 5, wherein said generally semi-cylindrical bushing halves include an internal semi-cylindrical pipe or tube receiving surface.

7. An attachment flange assembly as claimed in claim 5, wherein said internal semi-cylindrical pipe or tube receiving surfaces include at least one radially inward ridge to grip the outer cylindrical surface of the tube.

8. An attachment flange assembly as claimed in claim 1, wherein said annular flange plates include an inner surface and an outer surface with said conical contact surfaces diverging toward said inner surface and said flange plates are secured together with said inner surfaces in facing contact with each other.

9. An attachment flange assembly connecting a pipe or tube extending through a receiving hole in said wall, comprising:
a pair of annular flange plates secured to the wall in surrounding relation to said receiving hole;
each said flange plate including a conical contact surface disposed in diverging face-to-face relation;
a pair of generally semi-cylindrical bushing halves defining a split bushing assembly encircling the pipe or tube and defining an outer generally spherical surface,
a resilient seal ring interposed between said conical contact surfaces and said outer spherical surface.

10. An attachment flange assembly as claimed in claim 9, wherein said generally semi-cylindrical bushing halves include transverse end surfaces with said generally semi-cylindrical bushing halves disposed in end-to-end facing relation, and wherein said assembly includes a resilient bushing seal between said facing end surfaces, and wherein said resilient ring seal is compressed between said conical contact surfaces of said flange plates and said outer generally spherical surface of said split bushing assembly.

11. An attachment flange assembly as claimed in claim 10, wherein said generally semi-cylindrical bushing halves include an internal semi-cylindrical pipe or tube receiving surface secured to an outer cylindrical surface of said pipe or tube.

12. An attachment flange assembly as claimed in claim 11, wherein said annular flange plates include an inner surface and an outer surface with said conical contact surfaces diverging toward said inner surface and said flange plates are secured together with said inner surfaces in facing contact with each other.

13. An attachment flange assembly as claimed in claim 12, wherein said annular flange plates are secured to an outer surface of said wall.

14. An attachment flange assembly as claimed in claim 11, wherein said internal semi-cylindrical pipe or tube receiving surfaces include at least one radially inward ridge gripping said outer cylindrical surface of said pipe or tube.

15. A method of connecting a pipe or tube to a wall of a vessel employing an attachment flange assembly, comprising:
a pair of annular flange plates configured to be secured to the wall in surrounding relation to a receiving hole;
each said flange plate including a conical contact surface disposed in diverging face-to-face relation;
a pair of generally semi-cylindrical bushing halves defining a split bushing assembly positionable to encircle a pipe or tube and defining an outer generally spherical surface,
a resilient seal ring interposed between said conical contact surfaces and said outer generally spherical surface of said split bushing assembly;
the steps comprising:
positioning said split bushing assembly to encircle a pipe or tube;
securing said flange plates to the wall with said diverging conical contact surfaces in surrounding relation to said outer generally spherical surface of said split bushing assembly;
compressing said resilient seal ring between said conical contact surfaces of said flange plates and said radial outward generally spherical surface of said split bushing assembly.

16. The method as claimed in claim 15, wherein said generally semi-cylindrical bushing halves include transverse end surfaces and an outer generally semi-circular surface spherical between axially spaced edges, and wherein said generally semi-cylindrical bushing halves are disposed in end-to-end facing relation to form said split bushing assembly and said assembly includes a resilient bushing seal between said facing end surfaces.

17. The method as claimed in claim 16, wherein said generally semi-cylindrical bushing halves include an internal semi-cylindrical pipe or tube receiving surface, the method further including securing said internal semi-cylindrical pipe or tube receiving surface to an outer cylindrical surface of said pipe or tube.

18. The method as claimed in claim 17, wherein said internal semi-cylindrical tube receiving surfaces include at least one radially inward ridge to grip the outer cylindrical surface of the tube, said method further comprising gripping said pipe or tube with said at least one ridge.

19. The method as claimed in claim 17, wherein said annular flange plates include an inner surface and an outer surface with said conical contact surfaces diverging toward said inner surfaces of said flange plates, the method further comprising securing said flange plates together with said inner surfaces in facing contact with each other.

20. The method of 19 further comprising securing said annular flange plates to an outer surface of said wall.
